(19) United States
(12) Patent Application Publication
(10) Pub. No.: US 2026/0348085 A1
(43) Pub. Date: Nov. 5, 2026

(54) IMPROVING ADHESION OF FIBRE MATERIALS IN RUBBER COMPOSITES

(71) Applicant: BASF SE, Ludwigshafen am Rhein (DE)

(72) Inventors: Charles O KEROBO, Bloomfield Hills, MI (US); John Andrew RANDOLPH, Wyandotte, MI (US); Padma P VARANASI, Wyandotte, MI (US); David T DUROCHER, Wyandotte, MI (US); Christopher Anthony SICHMELLER, Wyandotte, MI (US); Mahmud HUSSAIN, Wyandotte, MI (US)

(73) Assignee: BASF SE, Ludwigshafen am Rhein (DE)

(21) Appl. No.: 19/115,397

(22) PCT Filed: Sep. 27, 2023
(86) PCT No.: PCT/EP2023/076648

§ 371 Date: Mar. 26, 2025

(30) Foreign Application Priority Data
Sep. 29, 2022 (EP) 22198903.1

(51) Int. Cl. D06M 15/61; D06M 13/11; D06M 13/513; D06M 15/356; D06M 15/693

(52) U.S. Cl. CPC D06M 15/61; D06M 13/11; D06M 13/513; D06M 15/3562; D06M 15/693; D06M 2200/12

(57) ABSTRACT

The present invention provides the use of hydrophobized polyethyleneimine for improving the adhesion of a fibre material to rubber in a rubber composite, wherein the hydrophobized polyethyleneimine has been hydrophobized to provide substituents which carry one or more pendant reactive groups. Included in this invention are a method for improving the adhesion of the fibre material to rubber in a rubber composite; a coated fibre material comprising a coated hydrophobized polyethyleneimine; a rubber composite comprising rubber and a fibre material, in which the fibre material has a coating of hydrophobized polyethyleneimine; methods for producing the coated fibre material and for producing the rubber composite; and aqueous formulation, suitable as a dipping solution, used for improving the adhesion of the fibre material to a rubber in a rubber composite.

### FIELD OF THE INVENTION

This invention generally relates to improving the adhesion of fibre materials in rubber composites. Specifically, the invention concerns the use of hydrophobized polyethyleneimines for improving the adhesion of a fibre material to rubber in rubber composites. Included in this invention are a method for improving the adhesion of the fibre material to rubber in a rubber composite; a coated fibre material comprising a coated hydrophobized polyethyleneimine; a rubber composite comprising rubber and a fibre material, in which the fibre material has a coating of hydrophobized polyethyleneimine; methods for producing the coated fibre material and for producing the rubber composite; and an aqueous formulation, suitable as a dipping solution, used for improving the adhesion of the fibre material to rubber in a rubber composite.

### BACKGROUND OF THE INVENTION

In the field of rubber composites fibre cords and woven fabrics are often incorporated to improve the structural rigidity of composite systems. These fibre cords and woven fabrics are often made from polar chemical structures making them chemically incompatible with nonpolar structures in rubber. To prevent the separation of these two disparate structures (i.e. the fibre cords/woven fabrics and the rubber) it is common practice to employ an adhesive system. Typically, this adhesive system would be a resorcinol-formaldehyde-latex (RFL) which would usually be imparted into the composite using a dip coating and then drying the adhesive solution onto the fibre component. The rubber is then attached to the fibre component by a vulcanisation process forming the final rubber composite.

While resorcinol-formaldehyde based resins have long remained state-of-the-art, recent advances in environmental and health studies have led to the classification of resorcinol and formaldehyde as unsafe chemical compounds. As a result, the rubber industry is currently seeking RFL free adhesive systems for use in the manufacture of rubber composites.

US Patent Publication 2017/0130396 A1 describes a formaldehyde and resorcinol free dipping solution for cord fabrics. The method described therein involves forming the dipping solution by adding acrylic polymer resin into water, adjusting the pH value, adding epoxy to the composition, adding polyisocyanate to the composition and then adding latex to obtain the dipping solution. Synthetic fibre and rubber used in the cord fabric reinforced rubber materials can be attached to each other by providing an interface between these two materials. The method is said to be not as hazardous as RFL for human health and is also environmentally friendly.

US Patent Publication 2020/0140657 A1 discloses a coated fibre for polymer reinforcement. The coated fibre comprises a fibre and a coating disposed about the fibre. The fibre has a denier of about 250 to about 3,000 and the coating comprises a branched polyethyleneimine. This document also describes a composite comprising: a polymer that comprises a thermoplastic, an elastomer or a thermoplastic elastomer; and the aforementioned coated fibre.

Despite these developments there is still a need to provide a viable RFL free adhesive system for rubber composites containing a fibre material reinforcement component with improved adhesive characteristics.

It is known to incorporate a variety of additives into rubber with the objective of improving various properties. For instance, EP 2810956, EP 1866368 and GB 953350 disclose silicone rubber/nitrile rubber mixtures comprising triethanolamine. CN 103601925 and CN 103554891 disclose mixtures comprising a special rubber, triethanolamine and optionally methyl triethoxy silane. Other additives include diphenylguanidine used as an accelerator in rubber mixtures (H.-d. Luginsland, A review on the chemistry and reinforcement of the silica silane filler system for rubber applications, Shaker, Aachen, 2002, P 49).

Japanese Patent Application No JP 2001003273 A described polyester fibre for reinforcing rubber which is provided with polyethyleneimine and epoxy compound on its surface. The polyester fibre said to have improved adhesive property.

Japanese Patent Application No JP H11222779 discloses a processing agent for polyester fibres containing polyethyleneimine, poly N-vinyl formamide or poly N-vinyl acetamide. The adhesiveness of the fibre and the rubber is said to be improved.

U.S. Pat. No. 3,597,265 relates to pass fibre coated with a lubricant comprising a partially amidated polyalkyleneimine having a residual amine value of from about 200 to 804 by reacting a polyalkyleneimine having a molecular weight of 800 to about 50,000 with a fatty acid.

US Patent Application No 2002/0017627 A1 concerns a polymer derivative comprising a polyalkyleneimine backbone having a number of reactive amino functionalities, each reactive amino functionality having at least one reactive hydrogen atom. From about 20% to about 60% of the number of reactive amino functionalities have a substituent compound substituted in place of the at least one reactive partition atom. Each substituent compound is said to be independently selected from the group consisting of carboxylic acids having from about 14 to about 20 carbon atoms.

US Patent Application No 2002/0028910 A1 describes a polymer derivative comprising a polyalkyleneimine backbone having a number of reactive amino functionalities. Each reactive amino functionality is said to have at least one reactive hydrogen atom. Eight, stabilising effective amount of the number of reactive amino functionalities have a substituent compound independently selected from the group consisting of carboxylic acids and amine protecting compounds substituted in place of the at least one reactive hydrogen atom. It is indicated that at least about 20% of the reactive amino functionalities have a carboxylic acid substituted in place of the at least one reactive hydrogen atom.

US Patent Application No 2004/0139559 A1 discloses a process for wrinkle proofing cellulosic textiles which comprises treating the textiles with a finish and trying the treated textiles. The finish is said to comprise one or more water soluble or water dispersible hydrophobically modified polyethyleneimines and/or poly vinyl amines. Suitable hydrophobically modified polyethyleneimines are said to be hydrophobically modified homopolymers of ethyleimine, hydrophobically modified graft polymers of polyamidoamines or of polyvinylamines. Suitable hydrophobically modified polyvinylamines are hydrophobically modified at least partially hydrolysed homo- or copolymers of N-vinylcarboxamides. The polyethyleneimines and polyvinylamines can be cross-linked by polyfunctional cross-linking compounds, quaternised and/or modified by reaction with alkylene oxides, dialkyl carbonates and/or C1-C4 carboxylic acids. Suitable hydrophobizing reagents are selected from the group consisting of long chain linear or branched linear carboxylic acids, linear or branched alkyl halides, alkyl epoxides, alkyl ketene dimers, cyclic dicarboxylic anhydrides, alkyl isocyanates and chloroformic esters of fatty alcohols.

Japanese Patent Application No JP 2016033170 claims a method for producing a latex foam, wherein polyethyleneimine and/or a polyethyleneimine derivative is further added to the rubber latex. Polyethyleneimine derivatives is said to include an epoxy modified polyethyleneimine obtained by reacting polyethyleneimine with an epoxy compound such as epichlorohydrin, and acrylic modified polyethyleneimine obtained by reacting polyethyleneimine with an acrylic compound such as acrylonitrile, an alkylated polyethyleneimine, halogen modified polyethyleneimine reacted with a halogen compound such as halide, isocyanate modified polyethyleneimine modified by reacting polyethyleneimine with an isocyanate compound such as alkyl isocyanate, fatty acid modified polyethyleneimine obtained by reacting polyethyleneimine with fatty acid, and the like.

US Patent No 11,059,961 B2 describes such an additive for rubber mixtures which is said to avoid the release of amines and achieves a high cross-linking density. The rubber mixture is said to comprise at least one rubber and at least one silane of formula G-Si(—OR)₃, wherein G is a monovalent, unbranched or branched, saturated or unsaturated, aliphatic, aromatic or mixed aliphatic/aromatic (C₂-C₁₆)— and R it is identical or different and is a straight-chain unsubstituted or branched unsubstituted (C₁-C₁₀)-alkyl.

U.S. Pat. No. 9,499,714 B2 concerns cross-linking of latex polymers with poly-functional amines. This reference describes latex polymer compositions, such as latexes, dispersions, microemulsions or suspensions. Said latex polymer compositions may be stored at room temperature or moderately above room temperature and provide adhesion and cross-linking upon film formation when applied to a substrate. The disclosure is said to include compositions of water-soluble polymeric and oligomeric polyfunctional amines for use as cross-linking agents in solutions of fast drying latex emulsions. The oligomeric/polymeric poly-functional amine is said to be synthesised in a single step reaction by reacting bi- or trifunctional glycidyl and/or glycidyl isocyanurate groups with water-soluble bi-, tri- and tetra-amines as the starting materials (reactants) serving as cross linkers for latex paints. Polymers and waterborne polymer compositions of this disclosure are said to be useful in a variety of paint and coating formulations such as architectural coatings, cementitious coatings, paper coatings, inks, and adhesives.

U.S. Pat. No. 10,246,571 B2 discloses polyfunctional amines with hydrophobic modification for controlled cross-linking of latex polymers. This reference describes the hydrophobic modification of various polyfunctional amines. One such reaction described is the synthesis of a structure in Reaction 6 by reacting polyethyleneimine with a hydrophobic glycidyl ether, such as butyl glycidyl ether. This structure is said to be a hydrophobically modified polyfunctional imine that is a quick drying agent and a homogenous solution used in modification of polyfunctional amines for cross-linking of latex particles. Reaction 7 describes the synthesis of an oligomer by reacting polyethyleneimine and a hydrophobic acrylic monomer emulsion, such as acrylic microemulsion. The oligomer so formed is said to be a hydrophobically modified polyfunctional imine that is a quick drying agent. Polymers and waterborne polymer compositions of this disclosure are said to be useful in a variety of paint and coating formulations such as architectural coatings, cementitious coatings, paper coatings, inks, and adhesives.

U.S. Pat. No. 10,377,878 B2 teaches controlled cross-linking of latex polymers with polyfunctional amines. This reference makes a very similar disclosure to U.S. Pat. No. 9,499,714 B2.

U.S. Pat. No. 10,851,240 B2 discloses compositions including a compound that can be prepared by the reaction of an optionally cross-linked polyethyleneimine and at least one amine reactive hydrolyzable organo-silane of the formula R—Z—SiY₃, where R represents an amine-reactive group containing 1-18 carbon atoms; Z represents a divalent organic group containing 1-8 carbon atoms, and each Y independently represents a hydrolysable group. The disclosure is said to provide reasonably stable one-pot curable PEI-derived compositions that can be applied to a substrate and cured to provide durable amine functional coatings on substrates. The reference indicates such coatings may be useful, for example, in chemical monitors (e.g. for monitoring exposure to an aldehyde disinfectant), and/or for modifying the hydrophobicity of and/or protecting a surface of a substrate.

Literature article, Multifunctional allyl-terminated hyperbranched poly(ethyleneimine) as component of new thiol-epoxy materials, Cristina Acebo et al., Reactive and Functional Polymers 99 (2016) 17-25, Elsevier, describes the synthesis of allyl terminated hyperbranched poly(ethyleneimine) and the characterisation. This was used in different proportions as a multifunctional macromonomer in tetra thiol-diglycidyl ether of bisphenol A formulations.

Literature article, Dielectric spectroscopy of novel thiol-ene/epoxy thermosets obtained from allyl-modified hyperbranched poly(ethyleneimine) and diglycidyl ether of bisphenol A, J D Badia et al., European Polymer Journal 113 (2019) 98-106, Elsevier, describes producing new thermosets by dual curing process consisting in a first photochemical thiol-ene, followed by a thermal thiol-epoxy starting from an allyl-terminated hyperbranched poly(ethyleneimine) and different proportions of diglycidyl ether of bisphenol A and the corresponding stoichiometric proportions of penta erythritol tetrakis(3-mercaptopropionate).

### SUMMARY OF THE INVENTION

In accordance with the present invention, we provide a use of a hydrophobized polyethyleneimine for improving the adhesion of a fibre material to rubber in a rubber composite, wherein the hydrophobized polyethyleneimine has been hydrophobized to provide substituents which carry one or more pendant reactive groups.

The present invention also provides a method for improving the adhesion of a fibre material to rubber in a rubber composite comprising the steps of:
providing an aqueous formulation comprising a hydrophobized polyethyleneimine;
contacting the fibre material by the aqueous formulation to form a coated fibre material; and
drying the coated fibre material,
wherein the hydrophobized polyethyleneimine has been hydrophobized to provide substituents which carry one or more pendant reactive groups.

A coated fibre material comprising a coating comprising hydrophobized polyethyleneimine, wherein the hydrophobized polyethyleneimine has been hydrophobized to provide substituents which carry one or more pendant reactive groups, wherein the coated fibre material has improved adhesion to rubber in a rubber composite that is obtainable by the formation method, is also included in the present invention.

The present invention further provides a method of producing a rubber composite comprising rubber and a fibre material, wherein the fibre material has an improved adherence to the rubber, comprising the steps of:
providing an aqueous formulation comprising hydrophobized polyethyleneimine; contacting the fibre material by the aqueous formulation to form a coated fibre material;
drying the coated fibre material;
contacting the coated fibre material and the rubber and vulcanising to form the rubber composite,
wherein the hydrophobized polyethyleneimine has been hydrophobized to provide substituents which carry one or more pendant reactive groups.

Additionally included in the present invention is a rubber composite comprising rubber and a fibre material, wherein the fibre material comprises a coating of hydrophobized polyethyleneimine, wherein the hydrophobized polyethyleneimine has been hydrophobized to provide substituents which carry one or more pendant reactive groups, which fibre material has an improved adherence to the rubber in a rubber composite, obtainable by the above-mentioned method.

In a further aspect of the present invention, we provide an aqueous formulation, suitable as a resorcinol formaldehyde latex (RFL) free dipping solution for improving the adhesion of the fibre material to a rubber in a rubber composite, wherein the aqueous formulation comprises:
A) a hydrophobized polyethyleneimine that has been hydrophobized to provide substituents which carry one or more pendant reactive groups; and
B) a latex.

### DESCRIPTION OF DRAWINGS

FIG. 1 illustrates the ¹H-NMR spectrum for the hydrophobized polyethyleneimine H-PEI Sample A.

FIG. 2 shows a graphical representation of the average peel strength for the rubber composites formed using comparative formulations 5 and 6 and the inventive formulations 7 and 9, all of which include the GLYMO® adhesion improver.

### DETAILED DESCRIPTION OF THE INVENTION

The one or more pendant reactive groups may be any suitable reactive group which can bring about cross-linking upon curing, for instance with heat, or during a vulcanisation process. Desirably the one or more pendant reactive groups may be silane groups or ethylenically unsaturated groups. Such ethylenically unsaturated groups are preferably selected from any of allyl, propargyl, acrylic or methacrylic groups.

Providing the hydrophobized polyethyleneimine with one or more pendant reactive groups would typically be achieved by reacting polyethyleneimine with a modifying agent which is reactive towards the polyethyleneimine to provide pendant moieties carrying the reactive group. Such a modifying agent would suitably contain a group that is reactive towards the amine groups of the polyethyleneimine and a further pendant group containing the pendant moieties containing the reactive group. Any suitable amine reactive groups may be employed. Preferably the amine reactive group may be any of the groups selected from epoxide, isocyanate, blocked isocyanate or acid anhydride.

A more preferred modifying agent is glycidyl allyl ether.

Suitably the hydrophobized polyethyleneimine comprises a structure represented by formula (I)

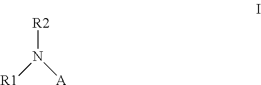

where
R1 represents a first fragment of the polyethyleneimine;
R2 represents a second fragment of the polyethyleneimine or represents hydrogen or is A; and
A is a hydrophobic group comprising one or more pendant reactive groups. The one or more pendant reactive groups may be any suitable reactive group which can bring about cross-linking upon curing, for instance with heat, or during a vulcanisation process.

Desirably A is a hydrophobic group derived from a hydrophobizing agent represented by the formula (II)

X—Y—Z II

wherein X represents an amine reactive group containing 1 to 6 carbon atoms bearing an epoxide or isocyanate group; Y represents a divalent organic group containing 1 to 8 carbon atoms; and Z represents one or more pendant reactive groups selected from silane groups or ethylenically unsaturated groups. The ethylenically unsaturated group may be any of allyl, propargyl, acrylic, methacrylic groups.

One graphical representation of a hydrophobized polyethyleneimine of formula (I) is depicted by the compound of formula (III):

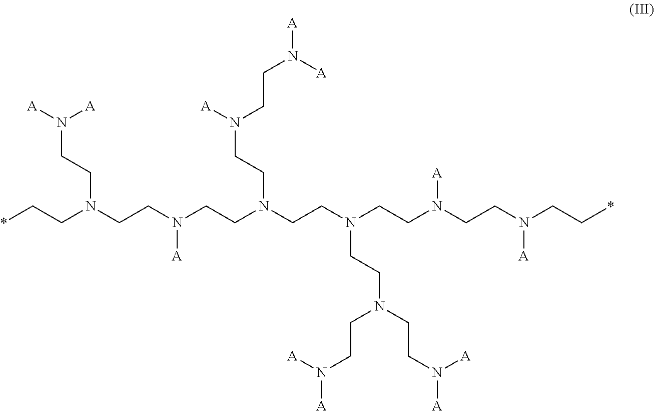

wherein A has the same definition as defined previously.

In a preferred embodiment of the hydrophobized polyethyleneimine the hydrophobizing agent represented by formula (II), X represents a glycidyl ether, y represents a divalent organic group containing 2 or 3 carbon atoms and Z represents an allyl group or silane group. The divalent organic group is desirably an alkylene group represented by any of:

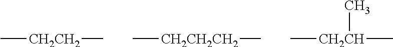

The hydrophobizing agent would generally react with the primary amines and/or secondary amines of the polyethyleneimine. A linear polyethyleneimine would generally contain secondary amines along its chain with primary amines distributed at the ends of the chain. Branched polyethyleneimines would also contain primary amines at the ends of the branches. Typically, two moles of the hydrophobizing agent can react with each primary amine and one mole of the hydrophobizing agent can react with each secondary amine.

The reaction between the polyethyleneimine and the hydrophobizing agent may be conducted in anhydrous conditions (i.e. in the absence of water). Thus, the polyethyleneimine and the hydrophobizing agent may each be provided as an anhydrous liquid. The reaction may then be carried out as an anhydrous reaction mixture. Alternatively, the reaction between the polyethyleneimine and the hydrophobizing agent may be carried out in the presence of water. In this case the polyethyleneimine and/or the hydrophobizing agent may be provided as aqueous compositions and then reacted together or the polyethyleneimine and hydrophobizing agent may be combined into an anhydrous reaction mixture which is then diluted with water prior to conducting the reaction. In one desirable form the polyethyleneimine is provided as an aqueous liquid and the hydrophobizing agent is either anhydrous or contains water. In one more desirable form the reaction mixture is an aqueous reaction mixture containing up to 60% water by weight of the aqueous reaction mixture, suitably comprising from more than 0% to 60% water, for instance from 10% to 55% water, such as from 20% to 55% water, in particular from 30% to 55% water, or from 40% to 55% water, such as from 45% to 55% water, especially about 50% water. Conducting the reaction in the presence of water offers the advantage that a polyethyleneimine produced initially as an aqueous liquid need not be rendered anhydrous by an additional processing step which would require energy to dehydrate the aqueous polyethyleneimine. Carrying out the reaction as an aqueous reaction mixture producing the hydrophobized polyethyleneimine as an aqueous composition may also negate adding water or as much water when forming the aqueous formulation.

Preferably the hydrophobized polyethyleneimine has a degree of functionalisation from 0.2 to 1.55.

The polyethyleneimine suitable for forming the hydrophobized polyethyleneimine can be made by various methods understood in the art. For example, the polyethyleneimine can be made by ring opening of aziridine by acid catalyzed polymerization. In certain embodiments, the polyethyleneimine can be further modified, such as by amidation with fatty acids, by alkoxylation with alkylene oxides, or by carboxylation with acrylic acid and/or maleic acid. Preferably the polyethyleneimine remains unmodified prior to hydrophobizing with the hydrophobizing agent.

In many embodiments, the polyethyleneimine has a weight average molecular weight (M_{w}) of from about 300 to about 2,000,000, about 400 to about 1,000,000, about 500 to about 900,000, about 500 to about 800,000, about 500 to about 25,000, g/mol. More preferably the weight average molecular weight (M_{w}) is from about 500 to about 15,000, from about 500 to about 10,000 g/mol and from about 500 to about 1500 g/mol.

In various desirable embodiments, the polyethyleneimine is a branched polymer comprising groups such as:

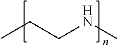

and/or

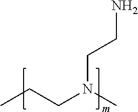

wherein n or m are typically about 9 to about 50,000 such that the polyethyleneimine has a weight average molecular weight (M_{w}) from about 500 to about 2,000,000 about 400 to about 1,000,000, about 500 to about 900,000, about 500 to about 800,000, about 500 to about 25,000, from about 500 to about 15,000, from about 500 to about 10,000 g/mol and from about 500 to about 1500 g/mol. It is also contemplated that the polyethyleneimine may have any value or range of values, both whole and fractional, within those ranges described above.

Preferably, the hydrophobized polyethyleneimine is derived from a branched polyethyleneimine. The polyethyleneimine is a branched polymer having the following exemplary structure:

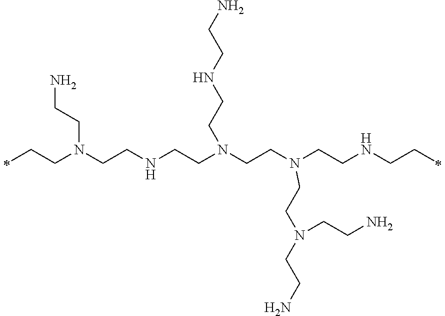

Still referring to the exemplary structure above, the branched structure of the polyethyleneimine provides primary, secondary, and tertiary amines. That is, the polyethyleneimine typically includes linear (L), dendric (D), and terminal groups (T). The above exemplary structure * represents the remainder of the polyethyleneimine molecule.

In some embodiments, the branched polyethyleneimine comprises: from about 20 to about 55, or from about 30 to about 45, percent linear groups (L); from about 10 to about 40, or from about 20 to about 30, dendric groups (D); and from about 20 to about 55, or from about 30 to about 45, percent terminal groups (T), based on 100 percent of all groups present in said branched polyethylene imine as determined via ¹³C-NMR in D₂O. In additional non-limiting embodiments, all values and ranges of values, both whole and fractional, within one or more of the aforementioned ranges, are hereby expressly contemplated.

In many embodiments, the branched polyethyleneimine has a degree of branching (DB) of from about 0.30 to about 0.85, from about 0.40 to about 0.75, or about 0.60 to about 0.70, as determined via ¹³C-NMR in D₂O and calculated with the Fréchet equation (DB=(D+T)/(D+L+T)). In additional non-limiting embodiments, all values and ranges of values, both whole and fractional, within one or more of the aforementioned ranges, are hereby expressly contemplated.

Suitable hydrophobized polyethyleneimine can be derived from polyethyleneimine commercially available from BASF under the tradename of LUPASOL®.

The hydrophobized polyethyleneimine is desirably formulated into an aqueous formulation. Typically, this aqueous formulation would comprise a latex and optionally other additives. The aqueous formulation can be applied to the fibre material by bringing said fibre material into contact with the aqueous formulation. The aqueous formulation could be applied to the fibre material by spraying it on the surface, however preferably the aqueous formulation is a dipping solution, which can be applied to the fibre material by submerging or dipping the fibre material into the aqueous formulation.

The latex preferably comprises a vinyl pyridine polymer. Typically, the vinyl pyridine polymer is a copolymer derived from vinyl pyridine at least one other ethylenically unsaturated hydrophobic monomer, preferably selected from styrene and butadiene. Preferably the latex is a terpolymer comprising vinyl pyridine, styrene and butadiene.

The optional other additives comprised in the aqueous formulation, especially when the aqueous formulation is a dipping solution, include adhesion improvers. In the present invention such adhesion improvers include compounds that are capable of reacting with amines. Suitably the adhesion improver is selected from any of epoxides, isocyanates, blocked isocyanates, acid anhydrides, acrylates, methacrylates or silanes. Typically, the silane would be a siloxyalkyl glycidyl ether.

The hydrophobized polyethyleneimine may be present in the aqueous formulation in any suitable amount that would be effective in promoting adhesion between the fibre material and the rubber in the rubber composite. Preferably the concentration of hydrophobized polyethyleneimine in the aqueous formulation, especially where this aqueous formulation is the dipping solution, is from 2% to 27% by weight of the weight of the aqueous formulation. Based on the weight of the solids content of the aqueous formulation the hydrophobized polyethyleneimine would be present in an amount ranging from 10% to 40% by weight. This would be particularly the case when the aqueous formulation is the dipping solution.

The preferred way of applying the hydrophobized polyethyleneimine to the fibre material is by incorporating the hydrophobized polyethyleneimine into an aqueous formulation as described above and dip coating onto the fibre material. Typically, the fibre material would be immersed in a bath of the aqueous formulation as a dipping solution for sufficient time to allow an adhesive coating to form on it. Suitably the period of immersion would be whatever is customary and appropriate for the particular industrial scale coating process.

It would be possible to immerse lengths of the fibre material into the bath of the dipping solution for the requisite period of time but on an industrial scale it would be more usual to use a continuous dip coating process in which the fabric material is continuously passed through the dip solution by means of a continuous roll to roll process where the fibre material is fed around rollers into, through and back out of the dip solution allowing sufficient time for the adhesive coating to form on the fibre material surface.

Once the coating comprising the hydrophobized polyethyleneimine has been applied to the fibre material the coating would normally undergo a drying stage to evaporate the water and any organic liquid for instance solvent. This may be achieved by subjecting the coated fibre material to a high temperature environment. Typically, the drying stage may be carried out at temperatures of at least 120 °C and me even be as high as 180 °C or higher. The drying stage may be for a period that would be customary and typical for the particular drying process employed in an industrial scale operation.

Thus, in one aspect of the present invention we provide a coated fibre material comprising a coating comprising the hydrophobized polyethyleneimine, wherein the coated fibre material has improved adhesion to rubber in a rubber composite that is obtainable by the aforesaid methods given hereinabove. The coated fibre material suitably comprises the fibre material (preferably as fibre cords and/or woven fabric) and an adhesive coating containing the hydrophobized polyethyleneimine disposed around the surfaces of the fibre material. Desirably the fibre material component of the article may form from about 80 to about 99.8, about 90 to about 99.8, about 90 to about 99, or about 92 to about 99 or about 93 to about 97% by weight of the total weight of the coated fibre material, typically with the remainder being made up by the adhesive coating. In addition, nonlimiting embodiments, all values and ranges of values, both whole and fractional, within one or more of the aforementioned ranges, are hereby expressly contemplated.

Typically, the fibre material should be provided as fibre cords and/or woven fabrics. Any suitable fibre may be employed for producing the fibre cords or woven fabrics. Suitable fibres can be selected from the group of polymeric fibres (e.g. acrylic, polyamide fibers, polyester fibers, polyolefin fibers, phenol-formaldehyde/novaloid fibers, etc.), natural fibers (e.g. cellulose fibers, lignin fibers, rayon fibers, wood fibers, etc.), glass fibers (e.g. E-glass, A-glass, E-CR-glass, C-glass, D-glass, S-glass, etc.), ceramic fibers, metallic fibers (e.g. stainless steel, aluminum, etc.), carbon and carbon composite fibers, (e.g. graphite fibers, polyacrylanitrile (PAN) based fibers, carbon nanotube fibers, etc.), mineral fibers (e.g. basalt fibers, etc.), and combinations thereof. In some embodiments, the fibers are composite or multi component fibers comprising any combination of suitable materials set for herein (polymer, metal, mineral, etc.). Examples of such composite fibers include nickel coated carbon fiber, silver coated fibers, and coextruded polymer fibers.

In one group of embodiments according to the present invention fibres forming the fibre material (e.g. fibre cord or woven fabric) are selected from the group of acrylic fibers, polyamide fibers, polyester fibers, polyolefin fibers, cellulose fibers, glass fibers, ceramic fibers, novoloid (phenol-formaldehyde) fibers, carbon fibers, mineral fibers, metal fibers, composite fibers comprising at least one of the aforementioned materials, and combinations thereof.

In other embodiments of the invention, the fibres forming the fibre material, comprise, consist essentially of, or consist of glass. In some such embodiments, the glass is further defined as E-glass fibers (alumino-borosilicate glass with less than 1% w/w alkali oxides, A-glass (Alkali-lime glass with little or no boron oxide), E-CR-glass (Electrical/Chemical Resistance; alumino-lime silicate with less than 1% w/w alkali oxides, with high acid resistance), C-glass (alkali-lime glass with high boron oxide content, used for glass staple fibers and insulation), D-glass (borosilicate glass, named for its low Dielectric constant), R-glass (alumino silicate glass without MgO and CaO with high mechanical requirements as reinforcement), and S-glass (alumino silicate glass without CaO but with high MgO content with high tensile strength).

In many embodiments, the fiber material comprises, consists essentially of, or consists of any polymer known in the art and can be produced in any way known in the art, e.g. wet spinning, hot extrusion, etc.

In some embodiments, the polymer forming the fibres of the fibre material are selected from polyamide, polyester, polyolefin, thermoplastic polyurethane (TPU), poly(vinyl alcohol) (e.g. PVOH, PVA, or PVAI), polyolefins (e.g. polyethylene (PE), ultra-high molecular weight PE (UHMWPE), polypropylene (PP)), and combination thereof.

In many embodiments, the fiber material comprises, consists essentially of, or consists of a polyamide fiber. The polyamide may be defined as the polymer comprising repeating amide, —CO—NH—, linkages. The polyamide may be a homopolymer (e.g. nylon 6) or a co-polymer (e.g. nylon 6,6, nylon 6/66). As defined herein, copolymers include two or more different monomers.

The polyamide can be an aliphatic, e.g. nylon, or aromatic polyamide, e.g. aramid. In some embodiments, the polyamide is a meta-aramid. In other embodiments, the polyamide is a para-aramid. Aramid fibers are a class of heat-resistant and strong synthetic fibers. In various embodiments, the terminology “consists essentially of” describes the polyamide itself as only a single compound, two compounds, three compounds, etc., and may be free of any other polyamides or compounds.

Typically, the polyamide may be or include, consist essentially of, or consist of one or more nylons, aramids, proteins, metal poly(aspartates) such as sodium poly(aspartate), and combinations thereof.

In some embodiments, the polyamide is an aliphatic or semi-aromatic polyamide such as nylon. Nylons are condensation copolymers typically formed by reacting diamines and dicarboxylic acids to form peptide bonds. In one embodiment, the nylon is further defined as having less than about 85 percent of amide-linkages attached directly (—CO—NH—) to two aliphatic groups. More specifically, the polyamide may be or include, consist essentially of, or consist of one or more of polyamide 6, polyamide 6,6, polyamide 6/66, polyamide 10/10, polyamide 10/12, poly(4-aminobutyric acid) (nylon 4), poly(7-aminoheptanoic acid) (nylon 7), poly(8-aminooctanoic acid)(nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6), poly(tetramethylenediamine-co-isophthalic acid) (nylon 4,1), polyhexamethylene isophthalamide (nylon 6,I), hexamethylene adipamide/hexamethylene-isophthalamide (nylon 6,6/61), hexamethylene adipamide/hexamethyleneterephthalamide (nylon 6,6/6T), poly(2,2,2-trimethylhexamethylene terephthalamide), poly(m-xylylene adipamide) (MXD6), poly(p-xylylene adipamide), poly(hexamethylene terephthalamide), poly(dodecamethylene terephthalamide), polyamide 6T/61, polyamide 6/MXDT/I, polyamide MXDI, a terpolymer of lauryl lactam, isophthalic acid and bis(4-amino-3-methylcyclohexyl)methane and polynorbornamide, and combinations thereof. Even more typically, the polyamide is chosen from polyamide 6, polyamide 6,6, polyamide 6/66, and combinations thereof. In other embodiments, the polyamide is chosen from polyamide 6, polyamide 6,6, polyamide 6/66, polyamide 12, polyamide 11, polyamide 6/10, polyamide 6/6.36, polyamide 6I/6T, and combinations thereof.

In preferred embodiments, the polyamide is an aromatic polyamide, i.e., aramid. Aramids are typically formed by reacting amines and carboxylic acid halides. In one embodiment, the aramid is further defined as having at least about 85 percent of amide linkages (—CO—NH—) attached directly to two aromatic rings. The aramid may be any known in the art, but is typically further defined as an AABB polymer, sold under tradenames such as Nomex®, Kevlar®, Twaron® and/or New Star™. As is well known in the art, NOMEX® and New Star™ include predominantly meta-linkages and are typically further defined as poly-metaphenylene isophthalamides. Kevlar® and Twaron® are both para-phenylene terephthalamides (PPTA), the simplest form of an AABB para-polyaramide. PPTA is a product of p-phenylene diamine (PPD) and terephthaloyl dichloride (TDC or TCI). Alternatively, the aramid may be further defined as the reaction product of PPD, 3,4′-diaminodiphenylether, and terephthaloyl chloride (TCI). In one preferred embodiment, the polyamide is poly-paraphenylene terephthalamide.

In various embodiments, the polyamide has a weight average molecular weight of greater than about 10,000, or greater than about 25,000, or from about 10,000 to about 1,000,000, or from about 50,000 to about 750,000, or from about 25,000 to about 500,000, g/mol. In additional non-limiting embodiments, all values and ranges of values, both whole and fractional, within one or more of the aforementioned ranges, are hereby expressly contemplated.

In another embodiment, the fiber material comprises, consists essentially of, or consists of a polyester fiber. The polyester may be defined as a polymer comprising repeating ester functional groups (esters). In other words, several esters are linked within polyester. Typically, alcohol is chemically reacted with carboxylic acid results to form the esters. Alternatively, the polyester may be defined as a polymer comprising at least about 85 percent by weight of an ester, a dihydric alcohol, a terephthalic acid. The polyester may be a homopolymer or a co-polymer.

In some embodiments, the polyester is an aliphatic polyester. Examples of suitable aliphatic polyesters include, but are not limited to, homopolymers such as polyglycolide or polyglycolic acid (typically formed via polycondensation of glycolic acid), polylactic acid (typically formed via ring-opening polymerization of lactide), polycaprolactone (typically formed via ring-opening polymerization of caprolactone), polyhydroxyalkanoate, and polyhydroxybutyrate. Examples of suitable aliphatic polyesters include, but are not limited to, copolymers such as polyethylene adipate, polybutylene succinate (typically formed via polycondensation of succinic acid with 1,4-butanediol), and poly(3-hydroxybutyrate-co-3-hydroxyvalerate (typically formed via copolymerization of 3-hydroxybutanoic acid and 3-hydroxypentanoic acid, butyrolactone, valerolactone with oligomeric aluminoxane as a catalyst), and polycyclohexylenedimethylene terephthalate (typically formed via formed from the polycondensation of terephthalic acid and cyclohexylene-dimethanol).

In other embodiments, the polyester is an aromatic polyester such as vectran™ (typically formed via polycondensation of 4-hydroxybenzoic acid and 6-hydroxynaphthalene-2-carboxylic acid).

In preferred embodiments, the polyester is a semi-aromatic polyester. Examples of suitable aliphatic polyesters include, but are not limited to, copolymers such as polyethylene terephthalate (typically formed via polycondensation of terephthalic acid with ethylene glycol), polybutylene terephthalate (typically formed via polycondensation of terephthalic acid with 1,4-butanediol), polytrimethylene terephthalate (typically formed via, polycondensation of terephthalic acid with 1,3-propanediol), and polyethylene naphthalate (typically formed via polycondensation of at least one naphthalene dicarboxylic acid with ethylene glycol).

In some specific embodiments, the polyester can be selected from a polyalkylene terephthalate such as polyethylene terephthalate, polybutylene terephthalate, polytrimethylene terephthalate, polyethylene naphthalate, polyethylene adipate, polyhydroxylalkanoate, polyhydroxyl butyrate, poly(3-hydroxybutyrate-co-3-hydroxyvalerate), polyglycolide, polylactic acid, the polycondensation product of 4-hydroxybenzoic acid and 6-hydroxynaphthalene-2-carboxylic acid, and polycaprolactone. In one particular embodiment, the rubber is further defined as a semi-crystalline thermoplastic polyester including, but not limited to, polyethylene terephthalate, polybutylene terephthalate, polytrimethylene terephthalate, polyethylene terephthalate-co-isophthalate, and combinations thereof. In one preferred embodiment, the rubber is polybutylene terephthalate. In another preferred embodiment, the rubber is polyethylene naphthalate.

In various embodiments, the polyester has a weight average molecular weight of greater than about 10,000, or greater than about 25,000, or from about 10,000 to about 1,000,000, or from about 50,000 to about 750,000, or from about 25,000 to about 500,000, g/mol. In additional non-limiting embodiments, all values and ranges of values, both whole and fractional, within one or more of the aforementioned ranges, are hereby expressly contemplated.

In some embodiments, the fiber material is further defined as comprising from about 2 to about 8, or from about 2 to about 4, ends or strands. As is known in the art, an “end” is a single strand comprising one or more filaments. In some embodiments, the fiber is bulk continuous filament or staple. In some embodiments, the fiber forming the fibre material can be drawn or non-woven. In other embodiments, the fiber material is woven or braided. The yarn can comprise ends of one material (e.g. just polyamide ends) or ends of more than one material (e.g. both polyamide and polyester ends). To this end, the fiber in the fibre material can be mono-end, multi-end, or staple yarn.

The fibre material may comprise fibres that have cross-sectional profiles of various shapes, such as round, ovular, triangular, rectangular, square, 5 sided, 6-sided, bell-shaped, star-shaped, bi-lobal, tri-lobal, flattened, etc. In some embodiments, the fibers are hollow.

In many embodiments, the fiber material comprises fibres having: a denier of from about 250 to about 3,000, from about 1,000 to about 2,500, or from about 1,400 to about 2,100; and/or a diameter of from about 0.1 to about 15, from about 0.3 to about 7.5, or from about 0.5 to about 3, μm. As defined herein, denier is the mass in grams per 9,000 meters of the fiber. In additional non-limiting embodiments, all values and ranges of values, both whole and fractional, within one or more of the aforementioned ranges, are hereby expressly contemplated.

More desirably the fibre material is a woven fabric or a fibre cord (preferably a woven fabric), preferably selected from any of polyester, polyamide, nylon 6.6, nylon 6, polyethylene terephthalate, polyethylene naphthalate, rayon, aramide, cotton or wool.

As provided for herein the present invention further provides a method of producing a rubber composite comprising rubber and a fibre material, wherein the fibre material as an improved adherence to the rubber, comprising the steps of:
providing an aqueous formulation comprising hydrophobized polyethyleneimine; contacting the fibre material by the aqueous formulation to form a coated fibre material;
drying the coated fibre material;
contacting the coated fibre material and the rubber and vulcanising to form the rubber composite,
wherein the hydrophobized polyethyleneimine has been hydrophobized to provide substituents which carry one or more pendant reactive groups.

Thus, after coating the fibre material and subjecting it to the drying stage as provided for herein above, the coated fibre material is then brought into contact with the rubber. This may be achieved by applying multiple layers of the rubber with the coated fibre material interposed between each of the rubber layers. The numbers of rubber layers forming the composite would be at least 2 and usually more, for instance at least 3. Suitably the composite may be formed from 2 to 10 rubber layers having 1 to 9 layers of coated fibre material interposed between each of the rubber layers, for instance from 3 to 8 rubber layers and 2 to 7 layers of coated fibre material interposed between each of the rubber layers.

Once the rubber composite has been constructed it would then be subjected to a heat treatment stage, typically a vulcanisation stage. Usually, the heat treatment or vulcanisation stage would be carried out at temperatures of at least of 120 °C, for instance even as high as 200 °C or higher and the heat treatment or vulcanisation stage may typically be for a period up to 30 minutes. It may be desirable to carry out the heat treatment of vulcanisation stage under high pressure, i.e. pressures of greater than one atmosphere. The exact pressure would tend to depend upon the particular industrial scale process employed.

The heat treatment or vulcanisation stage is believed to induce the pendant reactive groups in the hydrophobized polyethyleneimine to react and induce cross-linking which enhances the adhesion of the fibre material to the rubber in the rubber composite.

The term rubber used throughout this specification means either natural rubber or synthetic rubber and includes polymers selected from elastomers, thermoplastics, thermoplastic elastomers and combinations thereof.

The rubber can be a thermoplastic polymer or a thermosetting polymer. Thermoplastics have a relatively high molecular weight and molecular chains that associate through intermolecular forces, which weaken rapidly with increased temperature, and, thus, melt. As such, thermoplastics may be reshaped by heating and are typically used to produce parts by various polymer-processing techniques such as injection molding, compression molding, calendering, and extrusion. In contrast to thermoplastics, thermosets form irreversible chemical bonds when cured and, thus, do not melt, but decompose.

In many embodiments, the rubber is a thermoplastic polymer (thermoplastic). The thermoplastic can be an amorphous or crystalline polymer. Generally, crystalline polymers have a relatively sharp melting point, have a more ordered arrangement of molecular chains, and require higher temperatures to flow well when compared to amorphous polymers. Generally, amorphous polymers have no true melting point and soften gradually, have a more random orientation of molecular chains, and do not flow as easily as amorphous polymers. In some embodiments, the thermoplastic composition includes a combination of crystalline and amorphous thermoplastic polymers. In other embodiments, the thermoplastic composition includes thermoplastic elastomers, which can include crystalline and amorphous segments.

Various non-limiting examples of suitable thermoplastics and thermoplastic elastomers include polyolefins (e.g. PP, PE, ethylene/hexane copolymer, ethylene/acrylic acid, etc.), polyolefin elastomers, polyvinylchlorides (PVC), polyamides (PA), styrenic elastomers, thermoplastic vulcanate elastomer (TPV), fluoropolymers (e.g. PTFE, perfluoroelastomer, etc.), silicones, polyesters, polyester elastomers, polyoxymethylenes (POM), thermoplastic polyurethanes (TPU), and combinations thereof. In some preferred embodiments, the rubber is selected from thermoplastic polyurethane, polyoxymethylene, polyalkylene terephthalate, and combinations thereof.

In many preferred embodiments, the polymer is an elastomer (rubber). Various non-limiting examples of suitable elastomers include natural rubber (natural polyisoprene), synthetic polyisoprene, polybutadiene, chloroprene rubber, butyl rubber, halogenated butyl rubber, styrene-butadiene rubber, nitrile rubber, ethylene propylene rubber, ethylene propylene diene rubber (EPDM), epichlorohydrin rubber, polyacrylic rubber, silicone rubber, fluorosilicone rubber, fluoroelastomer, perfluoroelastomer, polyether block amides, chlorosulfonated polyethylene, and ethylene-vinyl acetate.

In many embodiments, rubber is included in the rubber composite in an amount of from about 5 to about 95, about 20 to about 90, about 30 to about 80, or about 40 to about 70, percent by weight based on the total weight of the rubber composite. Further, it is to be appreciated that more than one type of polymer may be included in the rubber composite (e.g. two different polymers), in which case the total amount of all polymers present in the rubber composite is within the above ranges. In additional non-limiting embodiments, all values and ranges of values, both whole and fractional, within one or more of the aforementioned ranges, are hereby expressly contemplated.

Various additives can be included in the rubber composite. Suitable additives include, but are not limited to, processing additives, plasticizers, chain terminators, surface-active agents, adhesion promoters, flame retardants, anti-oxidants, water scavengers, dyes, ultraviolet light stabilizers, fillers, acidifiers, thixotropic agents, curatives/cross-linkers, catalysts, blowing agents, surfactants, and combinations thereof. The additive(s) may be included in any amount as desired by those of skill in the art.

Preferably the rubber employed in the rubber composite is selected from any of ethylene propylene diene monomer rubber (EPDM), EE, natural rubber (NR), hydrogenated nitrile rubber (HNBR), styrene butadiene rubber (SBR), butyl rubber (IIR), nitrile rubber (NBR), neoprene rubber (CR), silicone rubber (Q), fluoroelastomer rubber (FKM) or polyurethane rubber (AU).

The following examples are intended to illustrate instant invention and are not to be viewed in any way as limiting the scope of the present invention.

### Examples

### Example 1—Synthesis of Hydrophobic Polyethyleneimine

Hyperbranched polyethyleneimine (PEI) sold commercially by BASF as Lupasol® FG (weight average molecular weight 800 g/mol), provided as an anhydrous product, was hydrophobized by reaction with allyl glycidyl ether (AGE) by a modified procedure disclosed in Acebo, C., et al., Reactive and Functional Polymers, 20 16.99: P 17-25.

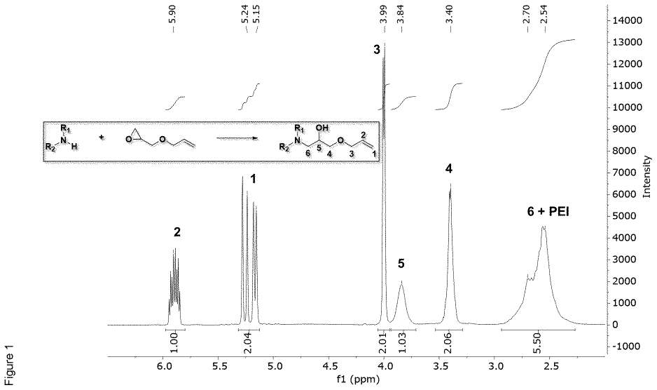

Lupasol® FG was heated to 50 °C in a reaction flask under nitrogen. Three weight equivalents of allyl glycidyl ether were then added dropwise to the reaction vessel over 5.5 hours and the exothermic reaction continued for 8 additional hours. The final product is identified as H-PEI Sample A. The reaction progress was determined by TLC (Thin Layer Chromatography) and the final structure was confirmed by ¹H-NMR. The ¹H-NMR spectrum is illustrated in FIG. 1.

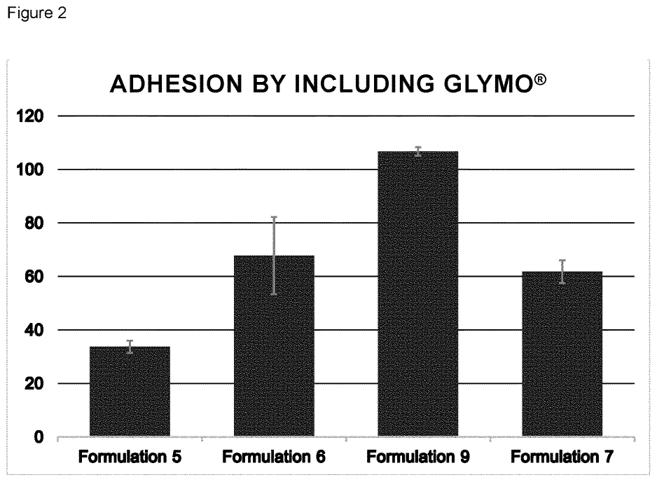

This synthesis was repeated with a ratio of PEI to AGE of 1:1 and 1:0.5. In both cases the reaction temperature is 50 °C. The products produced are identified as H-PEI Sample B and H-PEI Sample C respectively. Details of the syntheses of the three H-PEI Samples are given in Table 1. The ¹H-NMR spectra for the three samples are illustrated in FIG. 2.

TABLE 1

| | | | Total Reaction | |
|---|---|---|---|---|
| H-PEI Sample | Weight Ratio | Equivalent | Time | |
| A | 1:3 | 0.937 | 13.5 | hours |
| B | 1:1 | 0.312 | 6 | hours |
| C | 1:0.5 | 0.167 | 6 | hours |

### Example 2—Formulation of Adhesive Emulsion (Aqueous Formulation)

Adhesive formulations were prepared by dispersing 0.1 g Lutensol® XP90 (010 Guerbet alcohol ethoxylate (POE9) commercially available from BASF), 3 parts hydrophobized polyethyleneimine (H-PEI Sample A), and 33.9 g Pliocord® VP 106 (vinyl pyridine, styrene, butadiene polymer latex commercially available from Omnova Solutions) in 63 g deionised water. The dispersion was stirred until it was homogenous and then allowed to age overnight. This is identified as Formulation Sample 1. Analogous formulations to Sample 1 were prepared using hydrophobized polyethyleneimine H-PEI Sample B and H-PEI Sample C and these were identified as Formulation Samples 2 and 3 respectively. A comparative formulation was prepared by repeating the preparation for Formulation 1 by replacing the H-PEI Sample A by polyethyleneimine (Lupasol® FG) and is identified as Formulation Sample 4. A Control Formulation Sample was prepared using 0.1 g Lutensol® XP90, 33.9 g Pliocord® VP 106 and 66 g of deionised water i.e. without any hydrophobized polyethyleneimine or polyethyleneimine. This is summarised in Table 2.

TABLE 2

| | Adhesive Formulation Samples | | | | |
|---|---|---|---|---|---|
| Component | | 1 | 2 | 3 | 4 |
| (grams) | Control | (Inventive) | (Inventive) | (Inventive) | (Comparative) |
| Lutensol ® | 0.1 | 0.1 | 0.1 | 0.1 | 0.1 |
| XP90 | | | | | |
| Lupasol ® FG | 0 | 0 | 0 | 0 | 3 |
| H-PEI Sample | 0 | 3 | 0 | 0 | 0 |
| A | | | | | |
| H-PEI Sample | 0 | 0 | 3 | 0 | 0 |
| B | | | | | |
| H-PEI Sample | 0 | 0 | 0 | 3 | 0 |
| C | | | | | |
| Pliocord ® | 33.9 | 33.9 | 33.9 | 33.9 | 33.9 |
| VP106 | | | | | |
| Deionised | 66 | 63 | 63 | 63 | 63 |
| water | | | | | |

### Example 3—Dip Coating of Woven Fabric and Forming and Testing Composite

Each Formulation Sample listed in Table 2 was evaluated by dip coating onto a woven fabric and producing rubber composites which were tested. In addition, as a further comparison a standard RFL Formulation (Latex and Resorcinol Formaldehyde) was similarly tested.

Dip coating was performed on polyester fabric (6 inches×6 inches) by submersing in adhesive emulsion (Aqueous Formulation) for 30 minutes. The treated fabric was wrung out by hand and dried in an oven. Five-layer composites were made by alternating three layers of rubber with two layers of treated fabric and then heating (150 °C) under pressure for 20 minutes. The rubber composites were cooled for at least 24 hours before being cut into 1-inch strips for analysis via ASTM D413, entitled “Standard Test Methods for Rubber Property—Adhesion to Flexible Substrate”, ASTM International (http://www.astm.org/d0413-98r17.html). The peel strength was measured at the results shown in Table 3.

TABLE 3

| Formulation | Coating | Peel Strength (N) |
|---|---|---|
| Control Sample | Latex only | 32.4 ± 5.9 |
| Sample 1 (Inventive) | Latex + H-PEI (1:3) | 54.8 ± 6.6 |
| Sample 2 (Inventive) | Latex + H-PEI (1:1) | 54.6 ± 8.1 |
| Sample 3 (Inventive) | Latex + H-PEI (1:0.5) | 54.3 ± 9.9 |
| Sample 4 (Comparative) | Latex + Lupasol ® FG | 43.0 ± 4.0 |
| RFL Sample | Latex + RF | 64.5 |

The results demonstrate that the rubber composites made with the inventive hydrophobized polyethyleneimine (1:3) Formulation Sample 1 adhesive system have an average peel strength of 54.8 N; a result that is about 85% of the proprietary RFL system. Similar average peel strengths were observed from the hydrophobized polyethyleneimines (1:1) and (1:0.5) Formulation Samples 2 and 3 respectively. This system also demonstrated a superior adhesion of the inventive systems compared to the latex binder system (Control) and the latex polyethyleneimine system (Sample 4).

### Example 4—Co-Formulation of Hydrophobized PEI and Adhesion Improvers

Adhesive Emulsions (Aqueous Formulations) were prepared analogously to Example 2 including an additional adhesion improver the adhesion improver is selected from one of two compounds: GLYMO® (trimethylsiloxypropyl glycidyl ether) (CAS No 2530-83-8); and Trimethylol propane triglycidyl ether (TMPTE) (CAS No 30499-70-8). The compositions of each of the Aqueous Formulations are given in Table 4.

TABLE 4

| | Formulation Sample No. | | | | |
|---|---|---|---|---|---|
| Component | 5 | 6 | 7 | 8 | 9 |
| (grams) | Comparative | Comparative | Inventive | Inventive | Inventive |
| Lutensol ® XP90 | 0.1 | 0.1 | 0.1 | 0.1 | 0.1 |
| Lupasol ® FG | 0 | 3.0 | 0 | 0 | 0 |
| H-PEI Sample A | 0 | 0 | 3.0 | 0 | 0 |
| H-PEI Sample B | 0 | 0 | 0 | 3.0 | 3.0 |
| Pliocord ® VP106 | 33.9 | 33.9 | 33.9 | 33.9 | 33.9 |
| Deionised water | 63.0 | 60.0 | 60.0 | 61.7 | 60.0 |
| GLYMO ® | 3.0 | 3.0 | 3.0 | 0 | 3.0 |
| TMPTE | 0 | 0 | 0 | 1.3 | 0 |

The Adhesive Formulations 5-9 were each coated onto woven fabric, used to construct rubber composites and tested for adhesive strength as described in Example 3. The results are presented below in Table 5. The results for formulations 5, 6, 7 and 9 are also illustrated in FIG. 3.

TABLE 5

| Formulation | | Average Peel | Standard |
|---|---|---|---|
| Sample | Brief Description | Strength (N) | Deviation |
| 5 (Comparative) | Latex + GLYMO | 33.7 | 1.83 |
| 6 (Comparative) | Latex + GLYMO + PEI | 68.89 | 14.1 |
| 7 (Inventive) | Latex + GLYMO + A | 61.49 | 4.25 |
| 8 (Inventive) | Latex + TMPTE + B | 84.6 | |
| 9 (Inventive) | Latex + GLYMO + B | 107.48 | 1.16 |

The results demonstrate that on the whole the adhesive formulations containing hydrophobized polyethyleneimine and the additional adhesion improver provide the more effective results. Inventive formulations 8 and 9 provide the best results displaying an average peel strength of 84.6 N and 107.48 N respectively. Inventive formulation 7 displayed an average peel strength of 61.49, only marginally below the RFL proprietary formulation. Although the average peel strength for inventive formulation 7 is below the comparative formulation 6 corresponding to the formulation with unmodified polyethyleneimine comparative, formulation 6 shows a standard deviation of 14.1 which is significantly greater than that of inventive formulation 7 with a standard deviation of 4.25 illustrating that the performance of comparative formulation 6 was more variable than the inventive formulation.

### Example 5—Aqueous Synthesis of Hydrophobized Polyethyleneimine

Lupasol® FG (99%, water free) (30 g) was placed in a flask and 24.5 g of water added. The solution was exothermic reaction, raising the temperature to 45 °C. The reaction mixture was heated to 55 °C. Allyl glycidyl ether (33.5 g) was added over 100 minutes resulting in an exothermic to 70 °C. The reaction mixture was stirred at 60 °C for a further 4 hours 40 minutes to complete the reaction.

### Example 6—Aqueous Synthesis of Hydrophobized Polyethyleneimine

Lupasol® G20 (MW 1300 Da) (50% aqueous solution) (62.3 g) was placed in a flask and heated up to 50 °C. Allyl glycidyl ether (34.7 g) was added over 40 minutes resulting in an exothermic reaction temperature of up to 65 °C. The reaction mixture was stirred at 60 °C for a further 3.5 hours to complete the reaction.

1: A method for improving adhesion of a fibre material to rubber in a rubber composite, the method comprising:
applying a composition comprising a hydrophobized polyethyleneimine to the fibre material,
wherein the hydrophobized polyethyleneimine has been hydrophobized to provide substituents which carry one or more pendant reactive groups.

2: The method according to claim 1, wherein the one or more pendant reactive groups are selected from the group consisting of a silane group and an ethylenically unsaturated group.

3: The method according to claim 1, wherein the hydrophobized polyethyleneimine has been hydrophobized by a modifying agent having an amine reactive group.

4: The method according to claim 3, wherein the modifying agent is glycidyl allyl ether.

5: The method according to claim 1, wherein the hydrophobized polyethyleneimine comprises a structure represented by formula (I) 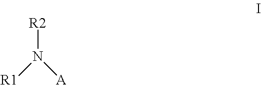
where
R1 represents a first fragment of the polyethyleneimine;
R2 represents a second fragment of the polyethyleneimine or hydrogen or is A; and
A is a hydrophobic group derived from a hydrophobizing agent represented by formula (II)
X—Y—Z II
wherein X represents an amine reactive group containing 1 to 6 carbon atoms bearing an epoxide or isocyanate group; Y represents a divalent organic group containing 1 to 8 carbon atoms; and Z represents one or more pendant reactive groups selected from the group consisting of an allyl group, a propargyl group, an acrylic group, a methacrylic group, and a silane group.

6: The method according to claim 5, wherein X represents a glycidyl ether, Y represents a divalent organic group containing 2 or 3 carbon atoms, and Z represents an allyl group or a silane group.

7: The method according to claim 1, wherein the hydrophobized polyethyleneimine has a degree of functionalisation from 0.2 to 1.55.

8: The method according to claim 1, wherein the hydrophobized polyethyleneimine is derived from a branched polyethyleneimine.

9: The method according to claim 1, wherein the hydrophobized polyethyleneimine is derived from a polyethyleneimine having a weight average molecular weight (Mw) from 500 to 10,000 g/mol.

10: The method according to claim 1, wherein the hydrophobized polyethyleneimine is derived from a branched polyethyleneimine having a degree of branching from 0.3 to 0.85 as determined by ¹³C-NMR in D₂O.

11: The method according to claim 1, wherein the hydrophobized polyethyleneimine is derived from a branched polyethyleneimine comprising from 30 to 45% linear groups, from 20 to 30% dendritic groups, and from 30 to 45% terminal groups, based on 100% of all groups present in the branched polyethyleneimine as determined by ¹³C-NMR in D₂O.

12: The method according to claim 1, wherein the hydrophobized polyethyleneimine is formulated into an aqueous formulation comprising a latex with which the fibre material is contacted.

13: The method according to claim 12, wherein the latex comprises a vinylpyridine polymer.

14: The method according to claim 12, wherein the aqueous formulation contains an adhesion improver, is capable of reacting with amines.

15: The method according to claim 14, wherein the adhesion improver is at least one selected from the group consisting of an epoxide, an isocyanate, an acid anhydride, an acrylate, a methacrylate, and a silane.

16: The method according to claim 15, wherein the adhesion improver contains a silane group, which is a siloxyalkyl glycidyl ether.

17: The method according to claim 14, wherein t the aqueous formulation contains the hydrophobized polyethyleneimine in a concentration of from 2% to 27% by weight of the aqueous formulation.

18: The method according to claim 14, wherein the aqueous formulation contains the hydrophobized polyethyleneimine in an amount of from 10% to 40% by weight of solids content of the aqueous formulation.

19: The method according to claim 1, wherein the rubber is at least one selected from the group consisting of ethylene propylene diene monomer rubber (EPDM), EE, natural rubber (NR), hydrogenated nitrile rubber (HNBR), styrene butadiene rubber (SBR), butyl rubber (IIR), nitrile rubber (NBR), neoprene rubber (CR), silicone rubber (Q), fluoroelastomer rubber (FKM), and polyurethane rubber (AU).

20: The method according to claim 1, wherein the fibre material is a woven fabric.

21: A method for producing a coated fibre material with improved adhesion to rubber in a rubber composite, the method comprising:
contacting a fibre material with an aqueous formulation containing a hydrophobized polyethyleneimine to form the coated fibre material; and
drying the coated fibre material,
wherein the hydrophobized polyethyleneimine has been hydrophobized to provide substituents which carry one or more pendant reactive groups.

22. (canceled)

23: A method of producing a rubber composite comprising rubber and a fibre material, the method comprising:
contacting the fibre material with an aqueous formulation containing a hydrophobized polyethyleneimine to form a coated fibre material;
drying the coated fibre material;
contacting the coated fibre material and the rubber and vulcanising to form the rubber composite,
wherein the hydrophobized polyethyleneimine has been hydrophobized to provide substituents which carry one or more pendant reactive groups.

24. (canceled)

25: A coated fibre material obtained by the method according to claim 21, comprising:
a coating comprising the hydrophobized polyethyleneimine.

26: A rubber composite obtained by the method according to claim 23, comprising the rubber and the coated fibre material.

27: An aqueous formulation, comprising:
A) a hydrophobized polyethyleneimine that has been hydrophobized to provide substituents which carry one or more pendant reactive groups; and
B) a latex.

28. (canceled)

29: The aqueous formulation according to claim 27, wherein the latex comprises a vinyl pyridine polymer.

30: The aqueous formulation according to claim 27, further comprising:
C) an adhesion improver capable of reacting with amines.

31: The aqueous formulation according to claim 30,
wherein the adhesion improver is at least one selected from the group consisting of an epoxide, an isocyanate, an acid anhydride, an acrylate, a methacrylate, and a silane.

32: The aqueous formulation according to claim 27, wherein the aqueous formulation contains the hydrophobized polyethyleneimine in a concentration of from 2% to 27% by weight of the aqueous formulation.

33: The aqueous formulation according to claim 27, wherein the aqueous formulation contains the hydrophobized polyethyleneimine in an amount of from 10% to 40% by weight of solids content of the aqueous formulation.
